(19) United States
(12) Patent Application Publication
(10) Pub. No.: US 2023/0316342 A1
(43) Pub. Date: Oct. 5, 2023

(54) METHOD FOR AUGMENTING DIGITAL ADS WITH INTERACTIVE FORMATS

(71) Applicant: Yieldmo, Inc., Nashua, NH (US)

(72) Inventors: David Sebag, New Paltz, NY (US); Jarrod Dowalter, Los Angeles, CA (US); Maziar Hosseinzadeh, New York, NY (US); RuiRui Yu, Oahu, HI (US); Sergei Izraelev, New York, NY (US); Alex Johnston, Seattle, WA (US)

(21) Appl. No.: 18/128,780

(22) Filed: Mar. 30, 2023

Related U.S. Application Data
(63) Continuation-in-part of application No. 16/857,139, filed on Apr. 23, 2020.
Application No. 16/857,139 is a continuation of application No. 15/872,688, filed on Jan. 16, 2018, now Pat. No. 10,692,531.
Application No. 15/872,688 is a continuation-in-part of application No. 15/048,994, filed on Feb. 19, 2016, now abandoned.
Application No. 15/872,688 is a continuation-in-part of application No. 15/466,603, filed on Mar. 22, 2017, now Pat. No. 10,789,983.
Application No. 15/466,603 is a continuation of application No. 15/217,879, filed on Jul. 22, 2016, now Pat. No. 9,852,759.
Application No. 15/217,879 is a continuation-in-part of application No. PCT/US15/64460, filed on Dec. 8, 2015.
(60) Provisional application No. 63/336,579, filed on Apr. 29, 2022.
(60) Provisional application No. 62/119,176, filed on Feb. 21, 2015.
(60) Provisional application No. 62/197,929, filed on Jul. 28, 2015.
(60) Provisional application No. 62/068,646, filed on Oct. 25, 2014.
(60) Provisional application No. 63/325,516, filed on Mar. 30, 2022.

(51) Int. Cl. G06Q 30/0241; G06Q 30/0251

(52) U.S. Cl. CPC G06Q 30/0277; G06Q 30/0255

(57) ABSTRACT

One variation of a method includes: receiving a request for advertising content from an ad slot loaded with a webpage rendered by a computing device; accessing a set of ad slot characteristics including an address of the webpage; extracting a set of visual assets, representing advertising content, from a digital advertisement selected for presentation within the ad slot; selecting a presentation layer, in a set of presentation layers, for pairing with the digital advertisement based on the set of visual assets and the set of ad slot characteristics, the presentation layer defining an interactive format and a layout of visual assets within the interactive format; transforming the digital advertisement into an interactive advertisement according to the presentation layer; and rendering the interactive advertisement within the ad slot responsive to an event that moves the ad slot within a viewing window of the computing device.

### CROSS-REFERENCE TO RELATED APPLICATIONS

This application claims the benefit of U.S. Provisional Application No. 63/336,579, filed on 29 Apr. 2022, and U.S. Provisional Application No. 63/325,516, filed on 30 Mar. 2022, each of which is incorporated in its entirety by this reference.

### TECHNICAL FIELD

This invention relates generally to the field of digital advertising and more specifically to a new and useful method for serving interactive advertising content in the field of digital advertising.

### BRIEF DESCRIPTION OF THE FIGURES

FIG. 1 is a flowchart representation of a method;

FIGS. 2A and 2B are flowchart representations of one variation of the method;

FIG. 3 a flowchart representation of one variation of the method; and

FIGS. 4A and 4B are flowchart representations of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

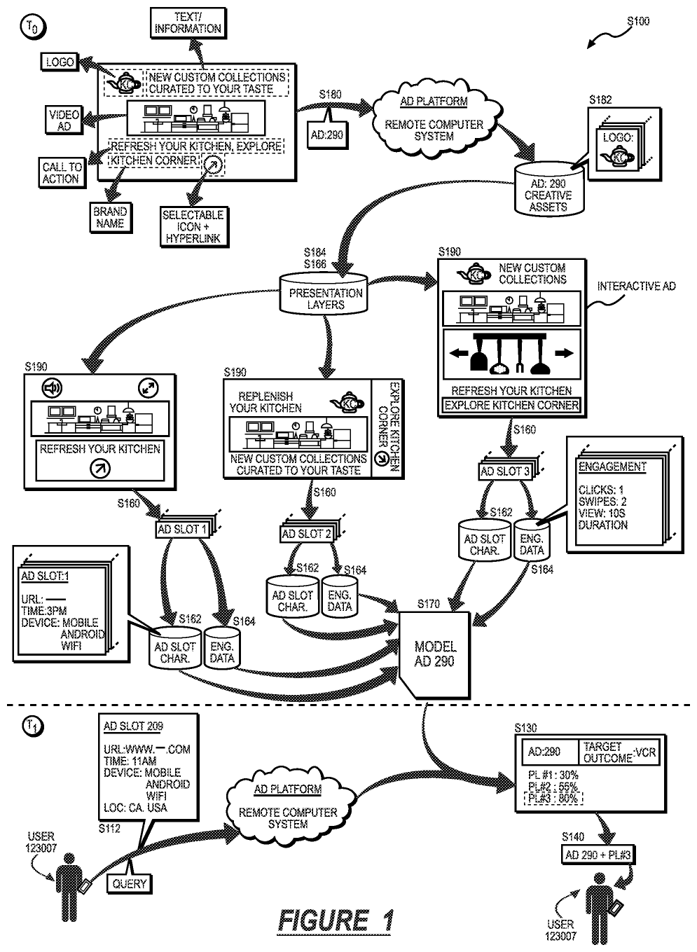

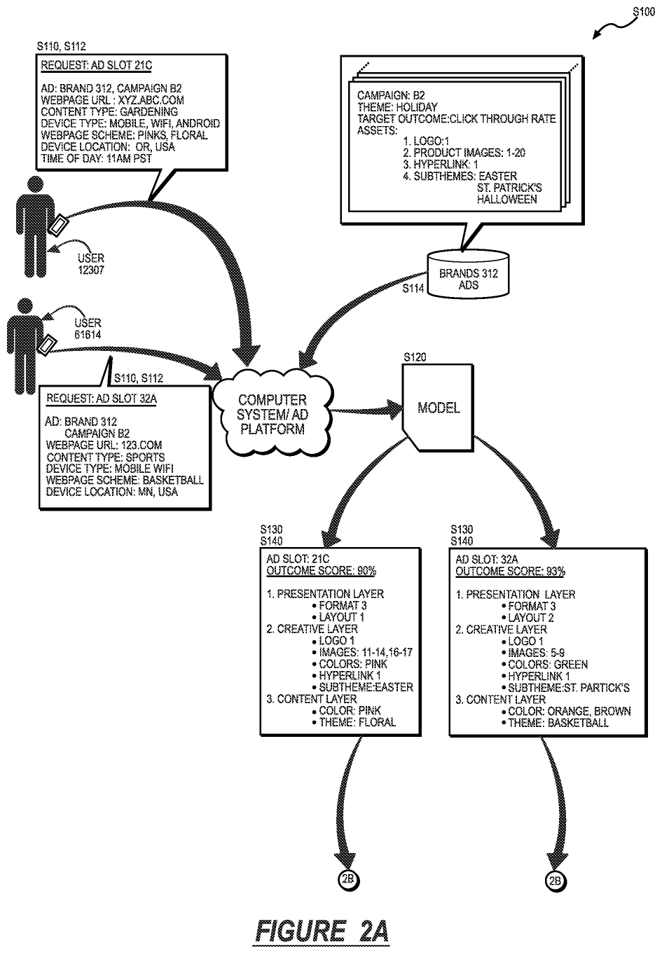

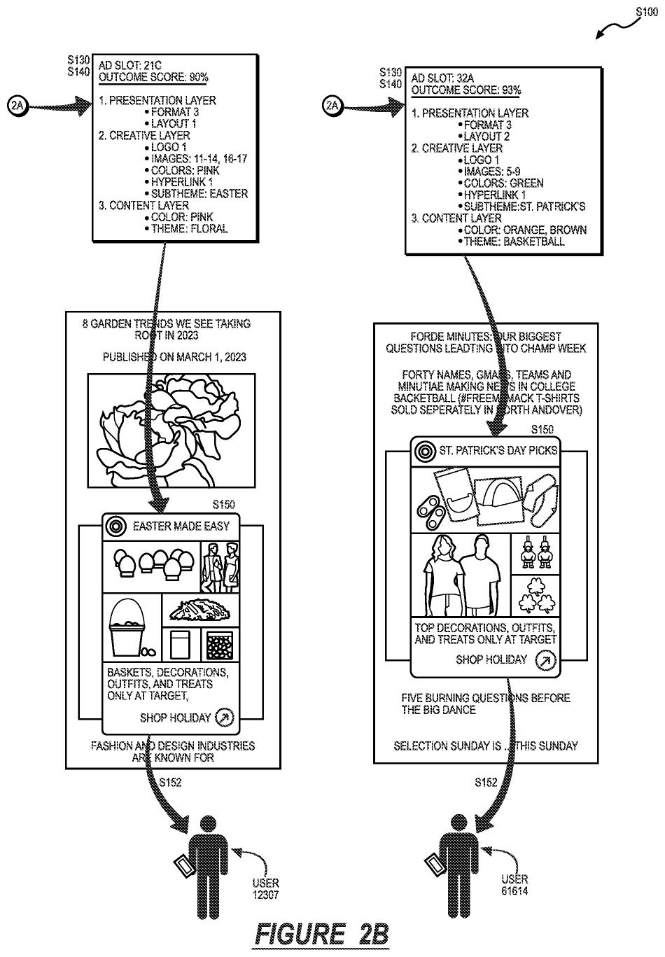

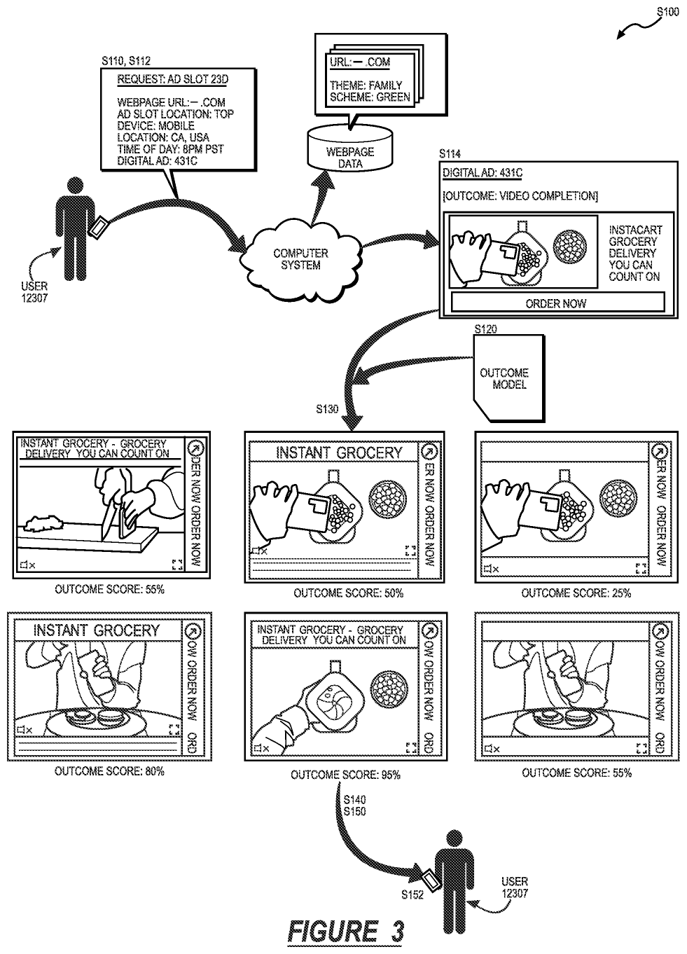

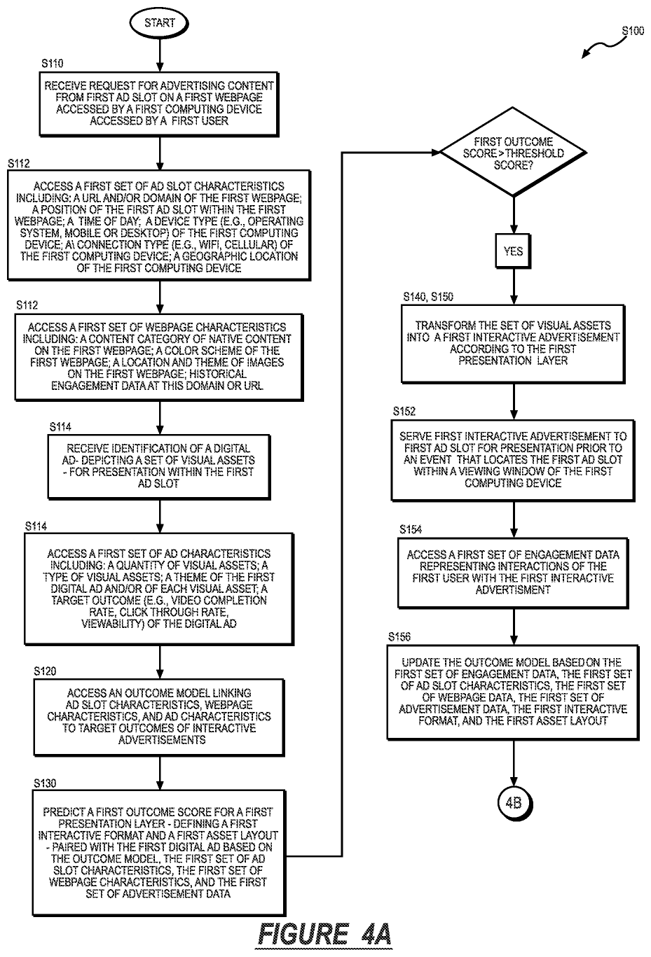

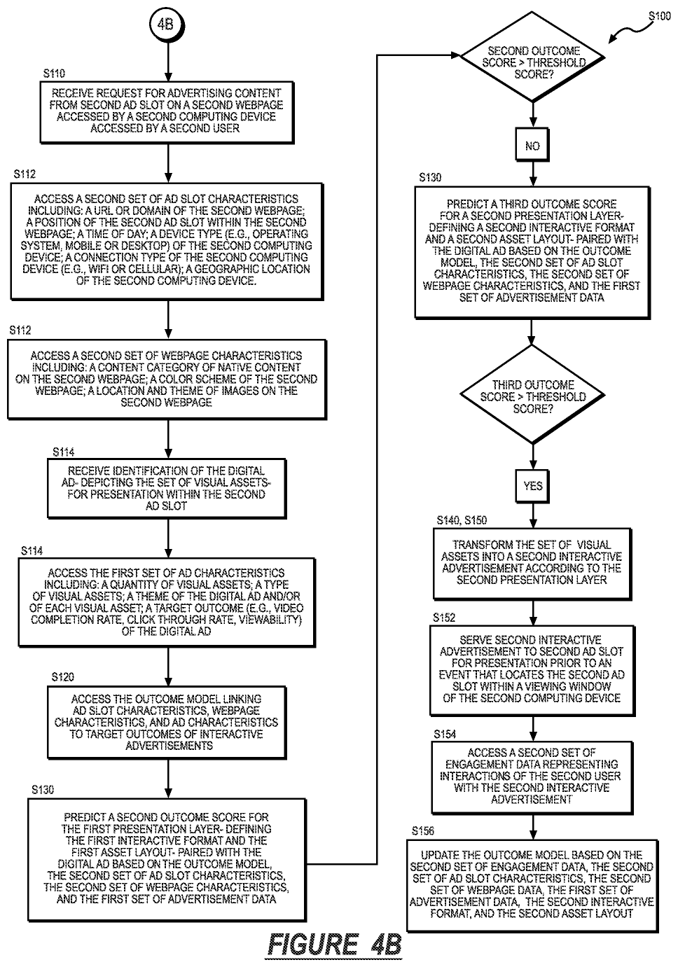

As shown in FIGS. 1, 2A, 2B, 3, 4A, and 4B, a method S100 includes, during a setup period: accessing a digital advertisement (e.g., a video ad, a static graphical image ad) including a set of assets representing advertising content in Block S180; extracting the set of assets from the digital advertisement in Block S182; accessing a set of presentation layers, each presentation layer, in the set of presentation layers, defining an interactive ad format, in a set of interactive ad formats, and a particular asset layout within the interactive ad format in Block S184; transforming the set of objects into a set of interactive advertisements according to the set of presentation layers in Block S190.

The method S100 further includes, during a test period succeeding the setup period: serving the set of interactive advertisements to a set of computing devices accessed by a population of users in Block S160; accessing a corpus of ad slot characteristics (e.g., webpage and/or native application metadata, URL, advertisement size, advertisement format, location on webpage, screen size, mobile or desktop device, device operating system, geographic location of device, time of day) of ad slots containing the set of interactive advertisements and rendered by the set of computing devices in Block S162; accessing a corpus of presentation layer characteristics (e.g., interactive ad format, asset layout) of presentation layers, in the set of presentation layers, served to the set of computing devices in Block S166; accessing a corpus of engagement data representing interactions (e.g., outcomes) of the population of users with the set of interactive advertisements presented within ad slots rendered by the set of computing devices in Block S164; and deriving a model associating ad slot characteristics, presentation layer characteristics, and user engagement with the set of interactive advertisements based on the corpus of ad slot characteristics, the corpus of presentation layer characteristics, and the corpus of engagement data in Block S170.

The method S100 further includes, during a live period succeeding the setup period, in response to receiving a first ad request from a first ad slot rendered within a first webpage executing on a computing device accessed by a user: accessing a first set of ad slot characteristics for the first ad slot in Block S112; for each interactive ad, in the set of interactive advertisements, predicting an outcome score, in a set of outcome scores, based on the set of ad slot characteristics and the model, each outcome score, in the set of outcome scores, representative of a probability of a user interacting with the interactive advertisement according to a particular target outcome (e.g., viewability, VCR, brand lift) defined by the digital advertisement in Block S130; and, in response to a first outcome score, in the set of outcome scores, corresponding to a first interactive advertisement and exceeding each other outcome score in the set of outcome scores, selecting a first interactive advertisement—including the first set of assets presented within a first presentation layer in the set of presentation layers—for presentation within the first ad slot in Block S140.

One variation of the method S100 includes, in response to receiving a first request for advertising content for presentation within a first ad slot loaded with a first webpage rendered by a first computing device accessed by a first user, accessing a first set of ad slot characteristics including a first address corresponding to the first webpage in Block S112. The method S100 further includes, in response to receiving identification of a first digital advertisement for presentation within the first ad slot: extracting a set of visual assets, representing advertising content, from the first digital advertisement in Block S114; accessing a model linking ad slot characteristics to outcomes of interactive advertisements defining a set of presentation layers, each presentation layer, in the set of presentation layers, defining a particular interactive format and a particular layout of visual assets within the particular interactive format in Block S120; and, based on the first set of ad slot characteristics and the model, predicting a first outcome score for a first presentation layer, in the set of presentation layers, paired with the first digital advertisement, the first outcome score representative of a probability of the first user interacting with advertising content presented according to the first presentation layer and within the first ad slot, according to a first target outcome defined for the first digital advertisement in Block S130. The method S100 further includes, in response to the first outcome score exceeding a threshold outcome score: selecting the first presentation layer for pairing with the first digital advertisement in Block S140; and transforming the set of visual assets according to the first presentation layer to generate a first interactive advertisement in Block S150.

In the preceding variation, the method S100 further includes, in response to receiving a second request for advertising content for presentation within a second ad slot loaded with a second webpage rendered by a second computing device accessed by a second user, accessing a second set of ad slot characteristics including a second address corresponding to the second webpage in Block S112. The method S100 further includes, in response to receiving identification of the first digital advertisement for presentation within the second ad slot: based on the second set of ad slot characteristics and the model, predicting a second outcome score for the first presentation layer paired with the first digital advertisement, the second outcome score representative of a probability of the second user interacting with advertising content presented according to the first presentation layer and within the second ad slot, according to the first target outcome in Block S130; and, in response to the second outcome score falling below the threshold outcome score, selecting a second presentation layer, in replacement of the first presentation layer, for pairing with the first digital advertisement in Block S140 and transforming the set of visual assets according to the second presentation layer to generate a second interactive advertisement in Block S150.

In one variation, the method S100 further includes, in response to serving the first interactive advertisement to the first ad slot for presentation to the first user, accessing a first set of engagement data representing interactions of the first user with the first interactive advertisement in Block S154; and rectifying the model based on the first set of engagement data, the first set of ad slot characteristics, and characteristics of the first presentation layer in Block S156.

One variation of the method S100 includes, during an initial time period: serving a set of interactive advertisements to ad slots rendered within webpages by a population of computing devices affiliated with a population of users, each interactive advertisement in the set of interactive advertisements including a first set of assets—representing advertising content for a first digital advertisement—and a presentation layer, in a set of presentation layers, defining an interactive format and an asset layout for the first set of assets in Block S160; accessing a corpus of ad slot characteristics of ad slots presenting the set of interactive advertisements in Block S162; accessing a corpus of engagement data representing interactions of users, in the population of users, with the set of interactive advertisements in Block S164; and deriving a model associating ad slot characteristics and user engagement with the set of interactive advertisements based on the corpus of ad slot characteristics and the corpus of engagement data in Block S170. In this variation, the method S100 further includes, during a first time period succeeding the initial time period: receiving a first request for advertising content for presentation within a first ad slot loaded with a first webpage rendered by a first computing device accessed by a first user in Block S110; in response to receiving the first request, accessing a first set of ad slot data including a first URL corresponding to the first webpage in Block S112; in response to receiving identification of the first digital advertisement for presentation within the first ad slot, based on the model and the first set of ad slot characteristics, predicting a first outcome score for a first interactive advertisement, in the set of interactive advertisements, presented within the first ad slot, the first outcome score representative of a probability of the first user interacting with the first interactive advertisement, presented within the first ad slot, according to a target outcome defined for the first digital advertisement, the first interactive advertisement including a first presentation layer, in the set of presentation layers, paired with the first digital advertisement in Block S130; and, in response to the first outcome score exceeding a threshold outcome score, selecting the first interactive advertisement for presentation within the first ad slot in Block S140.

In one variation, the method s100 further includes, during a setup period preceding the initial time period: accessing a digital advertisement including a set of assets representing advertising content in Block S180; accessing a set of presentation layers, each presentation layer, in the set of presentation layers, defining an interactive ad format, in a set of interactive ad formats, and a particular asset layout for arranging the set of assets within the interactive ad format in Block S184; and transforming the set of assets into the set of interactive advertisements according to the set of presentation layers in Block S190.

One variation of the method S100 includes: receiving a first request for advertising content for presentation within a first ad slot loaded with a first webpage rendered by a first computing device accessed by a first user, the first request specifying a first digital advertisement for presentation within the first ad slot in Block S110; and, in response to receiving the first request, accessing a first set of ad slot characteristics including a first URL corresponding to the first webpage, extracting a set of visual assets from the first digital advertisement in Block S112, and, accessing a model linking ad slot characteristics and characteristics of visual assets to user engagement with advertising content presented within ad slots in Block S120. In this variation, the method S100 further includes, based on the model, the set of visual assets, and the first set of ad slot characteristics: selecting a first interactive format, in a set of interactive formats, for pairing with the first digital advertisement in the first ad slot, the first interactive format defining animation of visual assets of the first digital advertisement in Block S140; and defining a first asset layout, in a set of asset layouts, for pairing with the first interactive format to form a first presentation layer, the first asset layout defining an arrangement of visual assets, in the set of visual assets, within the first interactive format in Block S140. The method S100 further includes: inserting a subset of visual assets, in the set of visual assets, into the first presentation layer according to the first asset layout to generate a first interactive advertisement in Block S150; and, at the first ad slot, in response to an event that locates the first ad slot within a viewing window of the first computing device, rendering the first interactive advertisement according to the first interactive format in Block S152.

One variation of the method S100 includes: receiving a request for advertising content for presentation within a first ad slot loaded with a webpage rendered by a computing device accessed by a user in Block S110; and, in response to receiving the request, accessing a set of ad slot characteristics including an address corresponding to the webpage in Block S112. In this variation, the method S100 further includes, in response to receiving identification of a digital advertisement for presentation within the ad slot: extracting a set of visual assets, representing advertising content, from the digital advertisement in Block S114; selecting a first presentation layer, in a set of presentation layers, for pairing with the digital advertisement, in the first ad slot, based on the set of visual assets and the set of ad slot characteristics, the first presentation layer defining a set of presentation layer characteristics including a first interactive format, in a set of interactive formats, and a first layout of visual assets within the first interactive format in Block S140; and transforming the set of visual assets into an interactive advertisement according to the first presentation layer in Block S150. The method S100 further includes: rendering the interactive advertisement within the ad slot responsive to an event that moves the ad slot within a viewing window of the computing device in Block S152; and, based on the event, generating an engagement metric for a user interacting with the interactive advertisement within the ad slot in Block S154.

### 2. Applications

Generally, the method S100 can be executed by an advertising (or “ad”) platform to transform a digital advertisement (e.g., a static advertisement)—including a set of discrete creative assets—into a dynamic (or interactive) advertisement and selectively serve this dynamic advertisement (or “interactive ad”) to an instance of a visual element inserted into a document accessed on a computing device (e.g., a smartphone, tablet computer, smartwatch, laptop, and/or other mobile computing device).

In particular, an ad platform (e.g., hosted by an ad platform) can receive a digital advertisement (i.e., a static, non-interactive ad) from an ad server, an advertiser, and/or any other internal or external server. The ad platform can then identify and label discrete creative assets within the digital advertisement, such as a video, an image, logos, faces, colors, text blocks, features, contextual information, etc., within the digital advertisement by implementing computer vision and machine learning techniques to extract key features and objects from the static asset. The ad platform can then: combine these creative assets (or “assets”) with a particular presentation layer—defining an interactive format and/or layout of assets within the interactive format—to transform the creative assets into an interactive advertisement that presents a combination of these creative assets according to a particular ad format and/or layout.

The ad platform can thus achieve many permutations of a single digital advertisement by combining creative assets—extracted from this single digital advertisement—with many different presentation layers to form a multitude of digital advertisement and presentation layer pairs (or “interactive advertisements”). The ad platform (in cooperation with a separate or coextensive ad server) can then strategically target combinations of digital advertisements and presentation layers (e.g., based on ad slot, environment, device, ad, and/or user characteristics) such that the resulting interactive advertisements draw greater attention from users viewing these interactive advertisements and thus yield more successful outcomes (e.g., greater engagement, brand lift, video-completion, click-through, viewability or conversion) than the corresponding (original) digital advertisement. In particular, the ad platform can leverage real-time characteristics of a particular impression—corresponding to a particular ad slot rendered within an electronic document (e.g., a webpage, a native application) by a computing device—to select a particular presentation layer predicted to yield high user engagement (e.g., according to a particular outcome) for serving to the ad slot.

In one implementation, the ad platform (or a “presentation layer server”) can select a presentation layer predicted to yield a particular outcome for a digital advertisement—selected for presentation within a particular ad slot—based on a set of local, real-time characteristics of the particular ad slot, such as: a URL of a webpage containing the ad slot; a domain of the webpage; an identity of a website containing the webpage; an integration method for advertising content defined for the ad slot (e.g., by the publisher); a time of day the ad slot was loaded on the webpage; a device type (e.g., mobile phone, smart watch, tablet, laptop, desktop computer) of a computing device rendering the ad slot; an operating system (e.g., android, iOS) of the computing device; a wireless carrier of the computing device; wireless connectivity of the computing device (e.g., WIFI, cellular); advertisement metadata (e.g., ad format, a product, type of product, and/or brand advertised in the digital ad) corresponding to the digital advertisement; webpage metadata (e.g., webpage publisher, content type or category of native content on the webpage, historical engagement data collected for this webpage) corresponding to the webpage containing the ad slot; etc. The ad platform can thus select and serve the selected presentation layer to an ad slot loaded within an electronic document (e.g., within a webpage, within a native application, within a video stream, within a video game stream) accessed on a user's computing device as the computing device loads this electronic document. Therefore, the ad platform can select a particular presentation layer—for combining with visual assets of a digital advertisement to form an interactive advertisement—predicted to achieve high user engagement when served in this particular ad slot.

In particular, the ad platform can augment the digital advertisement with this particular presentation layer to form the interactive advertisement predicted to yield high user engagement—according to a particular target outcome defined for the digital advertisement, such as video completion rate, click through rate, viewability, brand lift, etc.—when served to this particular ad slot. For example, for a first ad slot loaded within a first webpage, the ad platform can: select a first presentation layer—defining a first interactive format and/or a first layout of visual assets—for combination with a first digital advertisement defining a first target outcome of click-through rate; select a second presentation layer—defining a second interactive format and/or a second layout of visual assets—for combination with a second digital advertisement defining a second target outcome of video-completion rate; and/or select a third presentation layer—defining a third interactive format and/or a third layout of visual assets—for combination with a third digital advertisement defining a third target outcome of viewability. The ad platform can therefore selectively combine a particular presentation layer with the digital advertisement—to generate an interactive advertisement for presentation within a particular ad slot—based on both characteristics of this particular ad slot and the target outcome defined by the digital advertisement.

Furthermore, the ad platform can pair a digital advertisement with different presentation layers over time in order to identify presentation layers that yield best outcomes (e.g., highest engagement, greatest brand lift)—for the set of assets presented within this digital advertisement—when served in various ad slots, based on characteristics of these particular ad slots, such as webpage, device, and/or user characteristics. Therefore, the ad platform can enable rapid deployment of a new digital advertisement without necessitating selection or testing of individual assets (e.g., a call to action, a video or image, a color scheme) and/or a combination of assets in this new digital advertisement. Similarly, the ad platform can enable rapid deployment of a new presentation layer without necessitating selection or testing of the new presentation layer with existing digital advertisements. Rather, the ad platform (and/or an ad server) can pair existing advertisements with a new presentation layer over time to isolate combinations of digital advertisement assets and ad slot, webpage, device, and/or user characteristics that exhibit best outcomes when paired with this new presentation layer.

Further, in one implementation, the ad platform can augment a digital advertisement—selected for presentation within a particular ad slot, accessed by a computing device, and depicting a set of visual assets (e.g., logo, product images, digital video, heading, descriptions)—in (near) real-time based on a target outcome (e.g., video completion rate, click through rate, viewability) defined for this digital advertisement and characteristics of this particular ad slot (e.g., time of day, URL, location of ad slot within the webpage) in order to derive an interactive advertisement configured to maximize user engagement according to the target outcome when presented in this particular ad slot on this particular webpage. For example, the ad platform can select: a particular interactive format; a particular layout of visual assets within the interactive format; a particular selection of visual assets from the set of visual assets, for presenting within the interactive format; a color scheme; an overall theme (e.g., savings or discounts, holidays or events, membership, a particular product); an overall tone (e.g., playful, inspiring, practical); a background layer configured to match an overall feel or theme of the webpage, such as corresponding to a particular content type of native content on the webpage; etc. The ad platform can therefore: assemble visual assets, in the set of visual assets, according to these selections to generate an interactive advertisement tailored to this particular ad slot on this particular webpage; and then render this interactive advertisement within this ad slot, such as prior to an event (e.g., a scroll event, a click event) that locates the ad slot within a viewing window of the computing device.

### 3. Ad Serving

Generally, the ad platform can serve a visual element (e.g., an iframe element)—containing a digital advertisement and a presentation layer, configured to record engagement data (e.g., scrolls, tilts, swipes, gestures), and configured to return these engagement data to the ad platform—to a user's computing device. The user's computing device can then insert this visual element into an ad slot within a webpage rendered within a web browser executing on the mobile device. The visual element can render the digital advertisement wrapped with or covered by the presentation layer to form an interactive advertisement that responds to (i.e., changes responsive to) actions (e.g., user inputs) occurring on the computing device, such as scroll, swipe, tilt, or motion events.

In one implementation, the ad platform can retrieve or otherwise access a static asset (e.g., a static graphical advertisement and/or a digital video advertisement) from an internal or external database (e.g., a server or local file storage, such as a browser client). The ad platform (or a local computer system, as described below) can then transform the static asset into an interactive ad, as described below. The ad platform can package the interactive advertisement with a visual element that can later be inserted inline within a document (e.g., a webpage or mobile application) and can make the interactive advertisement and visual element package (or “interactive ad”) available for download by the advertiser; or upload the interactive advertisement to an ad exchange, to a publisher ad server, to an advertising agency ad server, or to another content distribution network.

Later, when a user navigates to a publisher's webpage via a web browser or to a mobile application via a native application (hereinafter an “app”) executing on her smartphone, tablet, or other computing device, a web server hosted by the publisher can return content or pointers to content for the webpage (e.g., in Hypertext Markup Language, or “HTML”, or a compiled instance of a code language native to a mobile operating system), including formatting for this content and a publisher ad tag that points the web browser or app to the publisher's ad server (e.g., a network of external cloud servers). The ad server can then implement an ad selector to: select a particular static asset (or ad); execute Blocks of the method S100 to transform the static asset into an interactive advertisement according to a selected ad format as described below; and serve the interactive advertisement to the web browser or application. In one implementation, the ad server can return the interactive advertisement directly to the web browser or application. Alternatively, the ad server can return a second ad tag that redirects the browser or app to an advertiser or publisher ad server. The advertiser or publisher ad server can then return a third ad tag that redirects the web browser or app to a content delivery network, which may include a network of cloud servers storing raw creative graphics for the ad, and the content delivery network can return the selected interactive advertisement to the web browser.

In the foregoing implementation, the ad server or content delivery network, etc. can return the interactive advertisement in the form of content within an HTML iframe element to the web browser or content within view in the mobile application. The mobile application can then place the iframe element within the webpage or within the window of the app. The visual element can then animate visual content of the interactive advertisement (e.g., seek through frames in the set of frame within the visual element) based on user interactions (e.g., clicks, swipes, scrolls, tilts) with the visual element shown within a window rendered on a display of the user's computing device.

### 3.1 Visual Element: Engagement Data

In one variation, a visual element is also configured to record engagement data and to return these engagement data to the ad platform—such as at a rate of 5 Hz—once the visual element is loaded into an ad slot within a webpage accessed at a mobile device. In one example, the visual element can record: its position in a web browser; a number or proportion of pixels of the visual element in view in the web browser; a running time that a minimum proportion of the visual element has remained in view; a number or instances of clicks on the visual element; vertical scroll events over the webpage; quality of these scroll events; horizontal swipes over the visual element; panes in the visual element viewed or expanded; tilt events and device orientation at the mobile device while the visual element was in view in the web browser; number or instances of hotspots selected; instances or duration of video played within the visual element; video pauses and resumes within the visual element or an expanded native video player; time of day; type of content on the webpage or other webpage metadata; and/or a unique user identifier. The visual element can compile these engagement data into engagement data packets and return one engagement data packet to the ad platform, such as once per 200-millisecond interval over the Internet or other computer network.

However, the visual element can define any other file format, can be loaded with a digital advertisement and/or presentation layer of any other type, and can collect and return engagement data of any other type to the ad platform in any other way and at any other interval once the visual element is loaded into a webpage rendered within a web browser on a mobile device.

### 4. Interactive Ad

Generally, the ad platform can pair a digital advertisement (or “ad”) with a presentation layer—defining a particular interactive ad format and/or content layout (or “asset layout”)—to form an interactive ad. In particular, the ad platform can: identify a set of creative assets (or “assets”)—such as a digital image or video, a logo (e.g., a brand logo), a call-to-action, and/or a hyperlink to an external webpage—represented in the digital advertisement; select a presentation layer—defining an interactive ad format and/or a particular asset layout—configured to highlight and/or augment these assets; and generate an interactive advertisement configured to present the set of creative assets (e.g., to a user viewing the interactive advertisement on a webpage rendered on a display of her computing device) according to the particular interactive ad format and/or the particular asset layout.

The ad platform can thus select and serve the selected presentation layer to a digital advertisement loaded into an ad slot in a webpage accessed on the user's computing device (e.g., mobile phone, laptop, smart watch, tablet, or desktop computer) as the computing device loads this webpage. The ad platform (e.g., as an advertisement server) and/or a separate ad server can then approximately concurrently select and serve the digital advertisement to a visual element (e.g., an iframe element) loaded in the ad slot as the user's computing device loads this webpage. The ad platform can thus combine a particular set of assets with a particular presentation layer to generate an interactive ad.

Therefore, the ad platform and a separate or coextensive ad server can select a presentation layer and a digital advertisement for pairing at a visual element to form an interactive advertisement in order to generate a new animation or new presentation and/or combination of creative assets presented in the digital advertisement—such as matched to environment, user, and/or digital advertisement characteristics—and thus increase user engagement with these creative assets and/or the digital advertisement.

### 4.1 Creative Assets

Generally, the ad platform can extract a set of creative assets (or “visual assets”) from a particular digital advertisement (e.g., a digital image or video) or a particular advertising campaign associated with a particular brand.

For example, the ad platform can access a set of creative assets (or a “group of assets”) including: primary visual advertising content (e.g., a static image and/or a digital video), such as a static image or video associated with an advertising campaign; a logo for the advertising campaign and/or for particular brand associated with the advertising campaign; textual content, such as a slogan for the advertising campaign and/or additional information regarding the brand or a product advertised in the primary visual advertising content; a call-to-action (or “CTA”); a hyperlink to an external website corresponding to the brand or product advertised; and/or a color pallet or a theme associated with the visual advertising content, product, ad campaign, or brand. The ad platform can then selectively combine these discrete assets—in combination with a particular presentation layer—to generate interactive advertisements of varying formats.

### 4.1.1 Asset Extraction

Generally, the ad platform can receive a digital advertisement including a set of assets (i.e., creative content)—such as text, iconography, images, and/or video—arranged in a static or dynamic ad format.

In one implementation, the ad platform can receive a digital advertisement (e.g., a static or dynamic digital ad) and identify a set of assets—such as a video, a primary image (e.g., a hero image) and/or secondary imagery, text, a set of colors, locations of faces, a set of characteristic and/or context tags, etc.—through computer vision techniques, such as optical character recognition (or “OCR”), natural language processing, label detection techniques, face detection techniques, image attributes extraction techniques, etc. For example, the digital advertisement (e.g., a 300-pixel by 250-pixel static advertisement image) can include text blocks, color pallets, images (e.g., images of faces, objects, places), context tags, hyperlinks to external websites, and/or other content related to advertisement of a particular brand and/or product, which the ad platform can then identify, label, and extract from the static asset.

In one variation, the ad platform can implement OCR techniques to detect text and delineate text blocks by size, color, typeface, formatting, and/or location within the static asset. Then, the ad platform can extract these discrete text blocks from the static asset. For example, the ad platform can differentiate between a text block corresponding to a brand logo, a text block representing a coupon code, and a text block representing a brand slogan despite juxtaposition of the three text blocks and extract these text blocks separately from the static asset.

In this implementation, the ad platform can extract the set of assets from the digital advertisement in (near) real-time in response to receiving identification of the digital advertisement for presenting within an ad slot rendered within a webpage. Additionally and/or alternatively, the ad platform can retrieve or otherwise access a set of assets—such as corresponding to a particular digital advertisement—from an internal or external database (e.g., a server or local file storage, such as a browser client). For example, during a setup period, an advertiser may upload a digital advertisement to a database accessed by the ad platform. The ad platform can then: extract a set of assets—such as a primary video, a call-to-action, a text block, and/or other thematic elements—from the digital advertisement; and store the set of assets in an advertisement profile, in a set of advertisement profiles, corresponding to the digital advertisement.

### 4.2 Presentation Layer

The ad platform can apply a particular presentation layer—defining a particular interactive format and/or a layout of visual assets (or an “asset layout”)—to a set of visual assets extracted from a (static) digital advertisement to generate an interactive advertisement configured to yield high user engagement with advertising content in the interactive advertisement, such as according to a particular target outcome (e.g., video completion rate, click through rate, viewability, conversion rate, brand lift) defined by the digital advertisement. Generally, the ad platform can generate and/or access a suite of presentation layers configured to present a set of visual assets according to a set of interactive ad formats and/or according to a set of asset layouts defined for each of these interactive ad formats.

### 4.2.1 Interactive Format

Generally, a presentation layer can define an interactive format for presenting creative content (i.e., visual assets)—such as text, iconography, images, and/or video—extracted from digital advertisements.

In one example, a presentation layer defining a first interactive format includes a static image overlaid with text and a link—selectable by a user—to an external webpage. In another example, a presentation layer defining a second interactive format contains a link to an external webpage and is configured to: start playback of a video (e.g., a primary video ad) when an ad slot containing the presentation layer enters a viewing window (e.g., rendered on a user device); and pause playback of the video when the ad slot exits the viewing window. In yet another example, a presentation layer defining a third interactive format: includes a set of virtual cards—each card including a unique image, iconography, and/or text and including a link to a unique external webpage—arranged horizontally in a magazine; and is configured to index laterally through the set of cards responsive to swipe inputs over the set of virtual cards, such as described in U.S. patent application Ser. No. 15/677,259, filed on 15 Aug. 2017, which is incorporated in its entirety by this reference. In another example, a presentation layer defining a fourth interactive format: includes a sequence of video frames and includes a link to an external webpage; is configured to index forward through this sequence of video frames responsive to scroll-down inputs at a webpage rendering an ad slot loaded within the presentation layer; and is configured to index backward through this sequence of video frames responsive to scroll-up inputs at the webpage, such as described in U.S. patent application Ser. No. 15/217,879, filed on 22 Jul. 2016, which is incorporated in its entirety by this reference.

In another example, a presentation layer defining a fifth interactive format includes a video ad and is configured to: overlay the video ad with a mask—including an aperture matched to a logo of a brand associated with the video ad—configured to obscure a portion of the video ad; and expand the aperture across the full width and height of the video ad as a function of position within a webpage rendering the video ad (e.g., as the user scrolls down within the webpage), such as described in U.S. patent application Ser. No. 17/349,706, filed on 16 Jun. 2021, which is incorporated in its entirety by the reference. In yet another example, a presentation layer defining a sixth interactive format includes a selectable video ad and a set of rotating child cards—presented adjacent the video ad—and is configured: to render the parent card within the visual element; trigger playback of the video advertisement from a first frame of the video advertisement; during playback of the video advertisement, render a first child card, in a set of child cards, adjacent the video advertisement (e.g., while continuing playback) within the expanded window in response to receiving selection of the video advertisement, the first child card including advertising content (e.g., a hero icon or image, a gif, a video) related to the video advertisement; render a transition from the first child card to a second child card, in the set of child cards, in response to a user input (e.g., a swipe) over the first child card; and render the second child card adjacent the video advertisement in replacement of the first child card, the second child card including additional advertising content related to the video advertisement, such as described in U.S. patent application Ser. No. 17/364,532, filed on 30 Jun. 2021, which is incorporated in its entirety by the reference.

However, the presentation layer can define any other type of interactive format for presenting and/or animating advertising content (e.g., visual assets) within ad slots.

In one implementation, each interactive format can define a set of target visual assets for presenting within the interactive format. For example, a first interactive format can define a first set of target visual assets including: a digital video; a set of three or more product images; and a call-to-action. In another example, a second interactive format can define a second set of target visual assets including: a static ad; a call-to-action; and a text description. Therefore, each presentation layer—defining a particular interactive format—can be configured to present a particular quantity or type of visual assets. The ad platform can thus selectively combine digital advertisements with presentation layers of particular interactive formats matched to visual assets specified by these digital advertisements.

### 4.2.2 Asset Layout+Interactive Format

In one implementation, the ad platform can: access a set of predefined interactive ad formats, such as stored in a remote database; and generate a multitude of presentation layers—configured for combination with digital advertisements to generate interactive advertisements—based on the set of predefined interactive ad formats.

In particular, in this implementation, the ad platform can access a set of interactive ad formats, each interactive ad format defining: an animation type for the presentation layer, assets within the presentation layer, and/or the resulting interactive ad; a set of asset rules, such as a minimum or maximum quantity of assets defined for this interactive ad format, and/or a particular type or types of assets required for and/or excluded from interactive advertisements of the interactive ad format; and a set of asset layouts—such as a set of maps defining target locations for different asset types within a presentation layer—for presentation of assets within presentation layers of the ad format.

Then, for each interactive ad format, in the set of interactive ad formats, the ad platform can generate a set of presentation layers corresponding to the interactive ad format. In particular, for a first interactive ad format, the ad platform can generate a first presentation layer: configured to present, reveal, animate, transform, etc. the set of assets according to the first interactive ad format; and defining a first asset layout—derived from the generic layout—for presentation of assets within the first presentation layer. Additionally, the ad platform can generate a second presentation layer: configured to present, reveal, animate, transform, etc. the set of assets according to the first interactive ad format; and defining a second asset layout—derived from the generic layout and distinct from the first asset layout—for presentation of assets within the second presentation layer. The ad platform can repeat this process to generate additional presentation layers—such as a third presentation layer, a fourth presentation layer, a fifth presentation layer, etc.—for the first interactive ad format. Further, the ad platform can repeat this process for each interactive ad format, in the set of interactive ad formats, to generate a multitude of unique presentation layers.

For example, the ad platform can access a first set of presentation layers defining a first interactive ad format including an animated mask overlaid a video ad—as described in U.S. patent application Ser. No. 17/349,706, filed on 16 Jun. 2021, which is incorporated in its entirety by the reference—such that the visual element can: overlay the video ad with a mask configured to obscure a portion of the video ad and including an aperture matched to a logo of a brand associated with the video ad; and expand the aperture across the full width and height of the video ad as a function of position of webpage (e.g., as the user scrolls down within the webpage). In this example, the ad platform can access a first presentation layer, in the first set of presentation layers, defining the first interactive ad format and a first asset layout defining: a first position (e.g., along a first side of the video ad) linked to a call-to-action; and a second position (e.g., along a bottom of the video ad) linked to a brand logo. The ad platform can also access a second presentation layer, in the first set of presentation layers, defining the first interactive format and a second asset layout defining: the first position linked to the brand logo; and the second position linked to the call-to-action. The ad platform can then generate: a first interactive advertisement including a set of assets extracted from the video ad presented according to the first presentation layer; and second interactive advertisement including the set of assets (and/or a different combination of these assets) presented according to the second presentation layer.

In the preceding example, the ad platform can further access a second set of presentation layers defining a second interactive ad format including a selectable video ad and a set of rotating child cards presented adjacent the video ad—as described in U.S. patent application Ser. No. 17/364,532, filed on 30 Jun. 2021, which is incorporated in its entirety by the reference—such that the visual element can: render the parent card within the visual element; trigger playback of the video advertisement from a first frame of the video advertisement; during playback of the video advertisement, render a first child card, in a set of child cards, adjacent the video advertisement (e.g., while continuing playback) within the expanded window in response to receiving selection of the video advertisement, the first child card including advertising content (e.g., a hero icon or image, a gif, a video) related to the video advertisement; render a transition from the first child card to a second child card, in the set of child cards, in response to a user input (e.g., a swipe) over the first child card; and render the second child card adjacent the video advertisement in replacement of the first child card, the second child card including additional advertising content related to the video advertisement. The ad platform can similarly generate multiple presentation layers, within the second set of presentation layers, defining different asset layouts, and generate multiple interactive advertisements from the single set of assets extracted from the video ad accordingly.

Alternatively, in another implementation, the ad platform can generate presentation layers in (near) real-time, such as in response to receiving identification of a digital advertisement for presenting within an ad slot loaded on a webpage. In this implementation, the ad platform can: access a set of advertisement characteristics (e.g., quantity of assets, asset types, ad format, advertising content); and select a particular ad format, from a set of predefined ad formats, defining a particular interactive animation and/or a particular asset layout. The ad platform can then generate a new presentation layer—such as defining a particular arrangement of assets within the interactive ad format—based on the particular interactive ad format and the set of advertisement characteristics.

### 5. Presentation Layer Selection: Presentation Layer+Digital Ad

The ad platform can select a presentation layer for combining with a digital advertisement—selected for serving to a particular ad slot—to generate an interactive advertisement predicted to achieve a target outcome (e.g., a minimum video completion rate, a minimum click-through-rate, a minimum viewability) when presented to a user within this particular ad slot. Over time, the ad platform can select different presentation layers for combining with this digital advertisement—selected for serving to a host of ad slots—to generate a multitude of interactive advertisements predicted to achieve the target outcome when presented to users within the host of ad slots.

The ad platform can therefore pair different presentation layers for presentation of a particular set of visual assets extracted from the selected digital advertisement for serving to different advertisement slots over time—such as for advertisement slots loaded on different webpages (e.g., URL, website, webpage metadata), rendered by different computing devices (e.g., device type, time of day, geographic location, wireless connectivity, wireless carrier), etc.—in order to better match (or “customize”) interactive features and/or presentation of these assets to predicted types of user interactions with advertising content presented in these advertisement slots, and thereby increase a likelihood of achieving the target outcome.

In one implementation, the ad platform can select a presentation layer for pairing with a digital advertisement in response to receiving a request for advertising content (e.g., an interactive advertisement, a presentation layer) from an ad slot loaded on a webpage—and/or within any other type of electronic document (e.g., a webpage, a native application)—rendered by a computing device (e.g., a mobile device, a desktop computer) accessed by a user. In particular, upon receiving identification of the digital advertisement—depicting a set of visual assets (e.g., a call-to-action, a title, a body of text, a set of images, a video)—specified by the request, the ad platform can: extract the set of visual assets from the digital advertisement; access a target outcome defined by the digital advertisement; select a presentation layer—defining an interactive format and/or an asset layout within the interactive format—predicted to achieve the target outcome (e.g., above a threshold probability) when paired with the digital advertisement in this particular ad slot; transform the set of visual assets into an interactive advertisement according to the presentation layer; and serve the interactive advertisement to the ad slot for presentation to the user, such as prior to an event (e.g., a scroll event, a click event, a swipe event) that locates the ad slot within a viewing window of the computing device.

### 5.1 Ad Slot Characteristics

In one implementation, the ad platform can select a presentation layer for pairing with a digital advertisement in a particular ad slot based on characteristics of the particular ad slot (or “ad slot characteristics”), such as including: a time of day; an address (e.g., URL) of a webpage containing the particular ad slot; a location of the particular ad slot within the webpage (e.g., top, middle, or bottom of the webpage); a set of webpage characteristics (e.g., URL, website, publisher, native content on the webpage, content type) of the webpage; a set of device characteristics (e.g., geographic location, device operating system, wireless carrier, wireless connectivity, device type) of a device (e.g., a computing device) rendering the particular ad slot; a set of ad characteristics (e.g., quantity or types of visual assets, ad format such as video or static image, product type, product, brand, color scheme, and/or advertisement metadata)—and/or characteristics of the set of visual assets—of the digital advertisement; and/or a set of user characteristics (e.g., the user's demographic, historical engagement with various presentation layers and digital advertisements).

For example, in response to receiving a first request for advertising content from a first ad slot—designated to receive a first digital advertisement defining a first target outcome (e.g., video completion rate, viewability, click through rate)—rendered within a first webpage executing on a first computing device accessed by a first user, the ad platform can: access a first set of ad slot characteristics—including environmental data (e.g., URL, webpage metadata, location of ad slot within the webpage, size of ad slot), device data (e.g., desktop or mobile, screen size, operating system, geographic location, time of day), ad data (e.g., static image or video, ad metadata), and/or user data—corresponding to the first ad slot; and select a first interactive advertisement—including a first set of assets, extracted from the first digital advertisement and presented according to a first presentation layer—for presentation within the first ad slot based on the first set of ad slot characteristics and the first target outcome. Later, in response to receiving a second request for advertising content from a second ad slot—designated to receive the first digital advertisement—rendered within a second webpage executing on a second computing device accessed by a second user, the ad platform can: access a second set of ad slot characteristics corresponding to the second ad slot; and select a second interactive advertisement—including the first set of assets presented according to a second presentation layer—for presentation within the second ad slot based on the second set of ad slot characteristics and the first target outcome.

Therefore, the ad platform can selectively assemble the set of assets—extracted from the first digital advertisement—according to: the first presentation layer for presentation in ad slots exhibiting characteristics linked to high user engagement—according to the first target outcome—with advertising content presented according to a first interactive format and/or a first asset layout defined by the first presentation layer; and the second presentation layer for presentation in ad slots exhibiting characteristics linked to high user engagement—according to the first target outcome—with advertising content presented according to a second interactive format and/or a second asset layout defined by the second presentation layer.

The ad platform can therefore select the best presentation layer—defining a particular interactive format, in a set of interactive formats, and/or a particular asset layout within the particular interactive format—for pairing with the selected digital advertisement in a particular ad slot in order to maximize a likelihood of achieving a target outcome defined by the digital advertisement.

### 5.1.1 Native Content

Additionally and/or alternatively, in one implementation, the ad platform can select a particular presentation layer for pairing with the digital advertisement—in a particular ad slot loaded within a webpage—based on a content type (e.g., business, health, sports, science) of native content presented within the webpage.

In particular, in this implementation, the ad platform can: receive a request for advertising content from an ad slot loaded on a webpage rendered by a computing device accessed by a user; receive identification of a digital advertisement—depicting a set of visual assets and defining a target outcome—selected for presentation within the ad slot; access a set of ad slot characteristics—including an address (e.g., URL) of the webpage—defined for the ad slot and specified in the request; based on the address, access a set of webpage data representing characteristics of the webpage including a content type (e.g., a content category)—such as business, finance, science, health, wellness, sports, cars, home goods, apparel, cooking, etc.—of native content presented within the webpage; and select a presentation layer, in a set of presentation layers, for pairing with the digital advertisement to generate an interactive advertisement predicted to achieve the target outcome when served to this ad slot.

For example, in response to receiving a first request for advertising content from a first ad slot—designated to receive a first digital advertisement depicting a first set of visual assets and defining a first target outcome—rendered within a first webpage executing on a first computing device accessed by a first user, the ad platform can: access a first URL of the webpage specified in the request; access a first content type (e.g., business) of native content presented on the first webpage based on the first URL; and, based on the first content type, select a first presentation layer, in a set of presentation layers, for pairing with the first digital advertisement to generate a first interactive advertisement predicted to achieve high user engagement—according to the first target outcome—when presented to the user within the first ad slot. Later, in response to receiving a second request for advertising content from a second ad slot—designated to receive the first digital advertisement—rendered within a second webpage executing on a second computing device accessed by a second user, the ad platform can: access a second URL of the webpage specified in the request; access a second content type (e.g., health and wellness) of native content presented on the second webpage based on the second URL; and, based on the second content type, select a second presentation layer, in the set of presentation layers, for pairing with the first digital advertisement to generate a second interactive advertisement predicted to achieve high user engagement—according to the first target outcome—when presented to the user within the second ad slot.

### 5.2 Ad Characteristics: Visual Assets

Additionally, in another implementation, the ad platform can select a presentation layer for pairing with a particular digital advertisement based on characteristics of the digital advertisement selected for presentation within a particular ad slot.

In particular, in this implementation, the ad platform can: receive confirmation of a digital advertisement for presentation within an ad slot loaded within a webpage rendered by a computing device accessed by a user; extract a set of visual assets—such as a logo, a call-to-action, a heading, a text body or description, a video ad, an image or images, a color scheme, a theme, etc.—from the digital advertisement; and, based on the set of visual assets—such as based on a quantity of visual assets, a type or types of visual assets, a quantity of each type of visual asset, a quality or characteristics of a particular visual asset (e.g., a duration of a video ad, a tone or theme associated with text or images) etc.—select a presentation layer for combining with the digital advertisement in the ad slot.

Additionally and/or alternatively, the ad platform can select a presentation layer for pairing with a particular digital advertisement—and in a particular ad slot—based on characteristics of the digital advertisement and a set of ad slot characteristics defined for the particular ad slot.

### 6. Outcome Model

In one variation, the remote computer system implements an outcome model configured to select presentation layers for pairing with digital advertisements served to ad slots in webpages viewed on user devices based on ad slot, environment (e.g., webpage), and/or ad characteristics and based on target outcomes of these advertisement and presentation layer combinations.

In particular, the remote computer system (and/or other computer system) can: serve interactive advertisements—including combinations of digital advertisements and presentation layers—to a population of users over time; record advertisement, presentation layer, ad slot, and/or webpage data (or “environment data”) for each interactive advertisement served to the population of users; record engagement data—representing outcomes of these interactive advertisements—for each interactive advertisement served to the population of users; derive correlations between ad characteristics (e.g., quantity and/or types of visual assets), ad slot characteristics, presentation layer characteristics (e.g., an interactive format and/or asset layout), webpage characteristics, combinations of digital advertisements and presentation layers, and outcomes of these interactive advertisements; and store these correlations in an outcome model (e.g., one generic outcome model; one outcome model per presentation layer; one outcome model per interactive format; one outcome model per digital advertisement; one outcome model per target outcome).

In one implementation, an advertiser or creative may specify a particular target outcome for a new ad campaign and/or for a particular advertisement. Once a digital advertisement is selected for a particular ad slot, the ad platform can implement the outcome model to pair the digital advertisement with a particular presentation layer predicted to increase a likelihood of achieving the particular target outcome—specified for this digital advertisement—when viewed within the ad slot by a user at the user's computing device (e.g., mobile device, desktop device). For example, an ad campaign can specify a target outcome including: video-completion rate (e.g., a at least a minimum proportion of a duration of a video ad spent viewing playback of the video ad); a click-through rate (e.g., a minimum proportion of advertisements clicked to total advertisements served); viewability rate (e.g., at least a minimum time spent viewing at least a minimum proportion of an ad); or click-through conversion rate (e.g., a minimum proportion of conversions to total advertisements served).

The ad platform can therefore derive an outcome model configured to select a presentation layer—for pairing with a digital advertisement to form an interactive advertisement—based on a predicted outcome of serving the interactive advertisement to a particular ad slot anticipating and/or corresponding to the target outcome.

### 6.1 Model Generation

In one variation, the ad platform automatically develops (or “learns”) an outcome model for a particular target outcome based on advertisement characteristics, engagement data, and outcomes recorded at ad slots containing advertising content served to a subset of users in a user population during a training period.

For example, during a training period, the ad platform can: serve interactive advertisements—including combinations of presentation layers and digital advertisements—to ad slots loaded on webpages accessed by computing devices of users in a subset of users in a user population; access interactive advertisement characteristics, such as including format, layout, and/or asset data; access ad slot characteristics (e.g., URL, website and/or native application, time of day, geographic location, device, advertisement metadata) for each ad slot; record engagement data (e.g., outcomes or user interactions with advertising content)—such as a number of scrolls back on forth over an advertisement, a duration a minimum proportion of an advertisement was visible in a viewport of the computing device, a location of an advertisement within a viewport of the computing device, a number of horizontal swipes across an advertisement, conversions, click-through, brand lift, viewability, video completion, etc.—with interactive advertisements presented in these ad slots; and, deduce interactive advertisement characteristics (e.g., presentation layer and/or ad characteristics)—such as a combination of interactive formats, asset layouts, and/or visual assets—and ad slot characteristics (e.g., time of day, URL, native content type, location of ad slot within the webpage, a device type, a device location) that anticipate particular user interactions or outcomes.

In particular, in one implementation, the ad platform can: leverage the set of engagement data to derive a set of outcomes associated with serving interactive advertisements to the user population; implement linear regression, artificial intelligence, a convolutional neural network, or other analysis techniques to derive correlations between ad characteristics, ad slot characteristics, and the set of outcomes; and store these correlations in an outcome model configured to predict outcomes of serving interactive advertisements in ad slots based on ad slot characteristics and interactive advertisement characteristics (e.g., interactive format, layout, asset data).

In one implementation, the ad platform can implement the methods and techniques described above to derive an outcome model linking ad slot characteristics and presentation layer characteristics to a set of target outcomes. In this implementation, the ad platform can store an outcome model configured to predict user engagement with a particular presentation layer—such as loaded with generic advertising content—when presented within a particular ad slot. In particular, in this implementation, the ad platform can predict engagement of a user—according to a particular target outcome—with advertising content presented in the particular ad slot based on characteristics of the presentation layer—such as the interactive ad format and/or asset layout—agnostic of identification of the digital advertisement and/or the set of assets.

Additionally and/or alternatively, in another implementation, the ad platform can implement the methods and techniques described above to derive an outcome model linking ad slot characteristics, characteristics of visual assets (or “creative assets”), and presentation layer characteristics to a set of target outcomes. Additionally and/or alternatively, in yet another implementation, the ad platform can implement the methods and techniques described above to derive an outcome model linking ad slot characteristics and interactive format types to a set of target outcomes. Additionally and/or alternatively, in yet another implementation, the ad platform can implement the methods and techniques described above to derive an outcome model linking characteristics of presentation layers and content types—of native content presented within webpages containing ad slots—to a set of target outcomes. Additionally and/or alternatively, in yet another implementation, the ad platform can implement the methods and techniques described above to derive an outcome model linking ad slot characteristics, characteristics of visual assets (or “creative assets”), and presentation layer characteristics to a set of target outcomes.

In one variation, the ad platform can store a set of outcome models associated with different target outcomes. The ad platform can then predict user interactions with a particular set of assets and/or a particular presentation layer—when presented within a particular ad slot—according to each target outcome, in a set of target outcomes, based on the set of outcome models. For example, the ad platform can store: a “VCR” model configured to predict a user's propensity to watch a minimum duration of a video ad presented within a particular ad slot based on ad slot, presentation layer, and/or ad characteristics; and a “viewability” model configured to predict a user's propensity to view at least a minimum proportion of pixels—over at least a minimum duration—of a digital advertisement presented in an ad slot based on ad slot, presentation layer, and/or ad characteristics.

### 6.1.1 Model Generation: Single Digital Advertisement

In one variation, the ad platform can transform a digital advertisement—including a set of creative assets—into a variety of formats (and/or into every possible ad format available) to generate a set of interactive advertisements and serve these interactive advertisements to a group of users to evaluate engagement with each interactive advertisement and, ultimately, converge on a high-engagement ad format for the digital advertisement when presented in various ad slots. In particular, in this variation, the ad platform can leverage a group of assets—such as associated with a particular primary ad (e.g., a static graphical advertisement, a video advertisement)—to generate a suite of interactive advertisements, each interactive ad, in the suite of interactive advertisements, of a particular interactive format, in a set of interactive formats. The ad platform can then serve this suite of interactive advertisements to ad slots (e.g., loaded on webpages) to identify high-engagement interactive ad formats for this particular group of assets for different types of ad slots (e.g., characterized by the ad slot characteristics), based on collected engagement data.

For example, during a setup period, the ad platform can receive a group of assets (e.g., provided by an advertiser) including: a primary video advertisement; a logo of a brand associated with the primary video advertisement; a call-to-action; a hyperlink to an external webpage associated with the primary video advertisement; a set of secondary images, such as corresponding to products advertised in the primary video advertisement and/or associated with the brand; and/or background imagery (e.g., static or dynamic background imagery). The ad platform can then leverage this group of assets to generate a set of interactive advertisements. In particular, the ad platform can: generate a first interactive ad, in the set of interactive advertisements, including a first subset of assets from the group of assets and defining a first ad format; generate a second interactive ad, in the set of interactive advertisements, including a second subset of assets from the group of assets and defining a second ad format (e.g., pinhole); and generate a third interactive ad, in the set of interactive advertisements, including a third subset of assets and defining a third advertisement format.

Then, during a test period succeeding the setup period, the ad platform can: serve the first, second, and third interactive advertisements to ad slots—such as a test population of ad slots—located on webpages accessed by a set of computing devices of users in a population of users; access ad slot characteristics (e.g., URL, website and/or native application identity, time of day, geographic location, device type, webpage and/or advertisement metadata) for each of these ad slots; record engagement data—representing user interactions with the first, second, and third interactive advertisements—for each instance of the first, second, and third interactive advertisement served; and implement linear regression, artificial intelligence, a convolutional neural network, or other analysis techniques to derive correlations between ad format characteristics, ad slot characteristics, and engagement data based on data gathered during the test period. The ad platform can then compile these correlations into an outcome model configured to predict user engagement—according to a particular target outcome (e.g., viewability, completion rate, click-through, brand lift) defined for the digital advertisement—with advertising content presented in a particular ad slot when presented in a particular format.

The ad platform can therefore identify a particular interactive advertisement—defining a particular interactive ad format—predicted to yield high user engagement with the group of assets when presented in a particular ad slot based on characteristics of the particular ad slot.

### 6.2 Outcome Scores

In one implementation, the ad platform can implement an outcome model configured to output an outcome score representative of a probability that a user will engage with (e.g., interact with or direct “attention” to) a particular interactive advertisement—including a set of assets extracted from a digital advertisement and a presentation layer applied to the set of assets—in a particular ad slot to achieve a particular target outcome (e.g., to output a prediction of the user's propensity to engage with advertising content according to the particular target outcome) based on: characteristics of the particular ad slot (e.g., URL of webpage, time rendered, placement of ad slot on webpage); characteristics of a computing device (e.g., device type, operating system, wireless connectivity, geographic location) rendering the particular ad slot; characteristics of a webpage (e.g., webpage metadata, website) containing the ad slot; advertisement characteristics of an advertisement selected for the ad slot; and/or characteristics of a user associated with the computing device.

In one implementation, the ad platform can store an outcome model configured to predict user engagement with a combination of a particular presentation layer and a set of assets—extracted from a digital advertisement—according to a particular target outcome (e.g., viewability, click-through, completion rate, brand lift) defined by the digital advertisement.

For example, in response to receiving a query for a presentation layer for pairing with a digital advertisement selected for presenting within a first ad slot loaded on a first webpage, the ad platform can: access a set of ad slot characteristics corresponding to the first ad slot; access a set of presentation layers (e.g., a set of predefined presentation layers); and access an outcome model associating characteristics of ad slots, presentation layer characteristics, and outcomes of advertising content presented within ad slots. Then, for each presentation layer in the set of presentation layers, the ad platform can: access a set of presentation layer characteristics, such as an interactive ad format and/or an asset layout within the interactive ad format; and predict an outcome score, in a set of outcome scores, based on the set of ad slot characteristics, the set of presentation layer characteristics, and the model, each outcome score, in the set of outcome scores, representative of a probability of a user interacting with advertising content presented within the first ad slot according to a target outcome (e.g., viewability, VCR, brand lift) defined by the digital advertisement. Finally, in response to a first outcome score, in the set of outcome scores, exceeding each other outcome score in the set of outcome scores, the ad platform can select a first presentation layer—corresponding to the first outcome score—from the set of presentation layers for pairing with the first digital advertisement.

Alternatively, in another example, in response to receiving a query for a presentation layer for pairing with a digital advertisement selected for presenting within a first ad slot loaded on a first webpage, the ad platform can: access a set of ad slot characteristics corresponding to the first ad slot; access a first presentation layer, in a set of presentation layers, defining a first set of presentation layer characteristics; access the outcome model; predict a first outcome score—representative of a probability of a user interacting with a set of assets, corresponding to the digital advertisement, presented within the first presentation layer and at the first ad slot according to a target outcome defined by the digital advertisement—for the first presentation layer based on the set of ad slot characteristics, the first set of presentation layer characteristics, and the model; and, in response to the first outcome score exceeding a threshold outcome score, select the first presentation layer for pairing with the digital advertisement at the first ad slot. Alternatively, in response to the first outcome score falling below the threshold outcome score, the ad platform can select a second presentation layer, in the set of presentation layers, for pairing with the digital advertisement at the first ad slot.

### 7. Dynamic Creative Layer+Presentation Layer

In one variation, the ad platform can select a creative layer—defining a particular group of visual assets—for pairing with a presentation layer to generate an interactive advertisement. In particular, in this variation, the ad platform can implement the methods and techniques described above to converge on high-engagement presentation layer and visual asset combinations—such as a presentation layer including particular text, iconography, images, video, color schemes, etc.—when served to a particular ad slot and/or type of ad slot (e.g., based on ad slot characteristics).

### 7.1 Dynamic Creative Layer: Predefined Ad Package

In one implementation, the ad platform can: access an advertisement package including a host of visual assets defined for a “dynamic” digital advertisement, such as defined by an advertiser and/or brand for a particular advertising campaign; and selectively assemble a group of visual assets, from the host of visual assets, into a creative layer for pairing with a particular presentation layer—defining an interactive format and/or layout of the group of visual assets within the interactive format—to form an interactive advertisement.

For example, a brand may define a digital advertisement or “digital advertisement package” defining a set of available visual assets for generating interactive advertisements for a particular “dynamic” digital advertisement and/or for a particular advertising campaign. In particular, in this example, the digital advertisement package can include a set of visual assets including: a logo affiliated with the brand and/or the digital advertisement package; a first digital video of a first duration; a second digital video of a second duration; a first color scheme (e.g., green and blue hues); a second color scheme (e.g., red, yellow, and orange hues); a set of 10 product images; a set of 10 descriptions corresponding to the set of 10 product images; a first call-to-action; a second call-to-action; a theme (e.g., holiday); a first subtheme (e.g., Halloween); a second subtheme (e.g., Thanksgiving); etc.

The ad platform can then leverage the set of visual assets to automatically generate a set of creative layers defining different combinations of visual assets in the set of visual assets. In one example, the ad platform can generate: a first creative layer including the logo, the first digital video, the first color scheme, 3 product images, the first call-to-action, and the first subtheme; a second creative layer including the logo, the second digital video, the first color scheme, 3 product images, the second call-to-action, and the second subtheme; a third creative layer including the logo, the first digital video, the second color scheme, 6 product images, the first call-to-action, and the second subtheme; etc. The ad platform can repeat this process to generate a suite of creative layers for combining with a suite of presentation layers—in multiple combinations and/or in each possible combination—to generate a corpus of interactive advertisements depicting different combinations of the set of visual assets presented according to a suite of interactive formats and/or a suite of asset layouts within each interactive format.

The ad platform can then: serve these interactive advertisements to ad slots rendered within webpages accessed by a population of computing devices; access ad slot characteristics and advertisement characteristics—such as characteristics of a creative layer and/or a presentation layer forming the interactive advertisement—for each interactive advertisement served to the population of computing devices; access engagement data representing outcomes of interactive advertisements served to the population of computing devices; derive correlations between ad slot characteristics, combinations of presentation layers and creative layers—and therefore combinations of interactive formats, asset layouts, and/or visual assets—and outcomes of serving these combinations to particular ad slots; and store these correlations in an outcome model configured to predict user engagement (e.g., according to a particular target outcome) with interactive advertisements—including different combinations of creative layers and presentation layers—based on characteristics of visual assets, presentation layer characteristics (e.g., interactive formats, asset layouts), and/or ad slot characteristics (e.g., for a particular ad slot). For example, in response to receiving a request for advertising content for presentation within a first ad slot, the ad platform can: access a first set of ad slot characteristics representative of the first ad slot; receive identification of a dynamic digital advertisement selected for presentation within the first ad slot; access a digital advertisement package—including a host of visual assets configured for assembly into the dynamic digital advertisement—defined for the dynamic digital advertisement (e.g., by a brand affiliated with the dynamic digital advertisement). In particular, in this example, the host of visual assets can include: a first representation of a logo presented in a first color; a second representation of the logo presented in a second color; a third representation of the logo presented in a third color; a set of 10 product images; a set of 10 descriptions corresponding to the set of 10 product images; a set of 5 color schemes; a set of 5 titles; a first call-to-action corresponding to a first theme (e.g., a promotion, an event, a product line) and/or a first tone (e.g., practical, inspiring, playful); a second call-to-action corresponding to a second theme and/or a second tone; a third call-to-action corresponding to the first theme and/or a third tone; a first digital video of a first duration (e.g., 8 seconds) and corresponding to the first theme and/or the first tone; a second digital video of a second duration (e.g., 15 seconds) and corresponding to the first theme and/or the first tone; a third digital video of the first duration and corresponding to the second theme and/or the second tone; etc. The advertisement package can further define: a target outcome (e.g., video completion rate, conversion rate, click through rate, viewability, brand lift) for the dynamic digital advertisement; and/or an overall theme (e.g., holiday and/or event, promotion, new product line) and/or a target objective for the dynamic digital advertisement, such as “discover new products,” or “purchase a membership,” or “view promotions on familiar products.”

Then, based on a quantity or type of visual assets, in the host of visual assets, and the set of ad slot characteristics, the ad platform can access a particular set of presentation layers—each presentation layer, in the set of presentation layers, defining a combination of an interactive ad format and an asset layout—configured for pairing with the dynamic digital advertisement in the first ad slot, such as based on compatibility of the interactive ad format (e.g., an interactive format requiring video, an interactive format requiring a static image(s) and omitting video, a format requiring video and static images) with the host of visual assets and the first ad slot. The ad platform can further generate a suite of creative layers—each creative layer, in the suite of creative layers, defining a unique combination of visual assets in the host of visual assets—configured for pairing with the set of presentation layers to form a suite of interactive advertisements.

The ad platform can then: access an outcome model linking ad slot characteristics, characteristics of presentation layers (e.g., interactive formats and/or asset layouts), and characteristics of creative layers (e.g., quantity and/or types of visual assets)—such as colors, static and/or dynamic images and video, duration of videos, product types in images and video, tone, theme, word choice in descriptions and call-to-actions, etc.—to outcomes of interactive advertisements; predict an outcome score, in a set of outcome scores, for each interactive advertisement, in the suite of interactive advertisements, based on the outcome model, the first set of ad slot characteristics, characteristics of each presentation layer, in the set of presentation layers, and characteristics of each creative layer in the suite of creative layers. The ad platform can then identify a particular interactive advertisement—including a combination of a particular presentation layer and a particular creative layer—exhibiting an outcome score exceeding a threshold score and/or exceeding each other outcome score of each other interactive advertisement in the set of interactive advertisements. The ad platform can thus: combine this particular creative layer—such as including the first representation of the logo, a subset of 3 product images, the second digital video, the first call-to-action, a particular color scheme, etc.—with this particular presentation layer to generate the interactive advertisement; and serve this interactive advertisement to the first ad slot accordingly, such as prior to an event that locates the first ad slot within a viewing window of a computing device rendering the first ad slot.

Additionally and/or alternatively, in another implementation, the ad platform can receive a digital advertisement—depicting a set of visual assets (e.g., a call-to-action, a description, a title, a video, product images)—and automatically delineate each visual asset, in the set of visual assets, such as by implementing computer vision and machine learning techniques to extract key features and objects from the digital advertisement, as described above. In this implementation, the ad platform can then implement the methods and techniques described above to derive a particular combination of visual assets predicted to achieve high user engagement (e.g., according to a particular target outcome) and generate a creative layer—for combination with a particular presentation layer—including this particular combination of visual assets accordingly.

### 7.2 Environment-Specific: Content Layer

Additionally and/or alternatively, in one variation, the ad platform can select a content layer—depicting visual content defining a particular theme (e.g., color, content category) matched to a particular webpage and/or a particular advertisement—for pairing with the presentation layer and/or creative layer to generate the interactive advertisement.

In particular, in this variation, the ad platform can generate a content layer—such as an ad slot overlay arranged beneath the presentation layer and/or creative layer within the ad slot—depicting visual content (e.g., colors, patterns, shapes, iconography) contextually related to a content type of native content on a webpage containing the ad slot. The ad platform can repeat this process to generate a suite of content overlays, such as in (near) real-time and/or during an initial set up period. The ad platform can then implement the methods and techniques described above to converge on high-engagement content layer, presentation layer, and/or creative layer combinations for a set of target outcomes (e.g., VCR, CTR, viewability) when served to ad slots loaded within webpages including native content of a particular content type.

For example, the ad platform can select a first content layer—defining an orange color scheme and iconography associated with basketball—for pairing with a first presentation layer and a first creative layer in a first ad slot arranged on a webpage presenting content related to sports. Alternatively, the ad platform can select a second content layer—defining a blue color scheme, corresponding to a color scheme of the first creative layer, and iconography associated with basketball—for pairing with the first presentation layer and the first creative layer in the first ad slot. The ad platform can thus select and/or generate the content layer based on characteristics of the ad slot, webpage, presentation layer, and/or creative layer.

In one implementation, the ad platform can automatically generate new color schemes, patterns, images, etc. for presenting within the content layer in (near) real-time —such as in response to receiving identification of the digital advertisement and/or selection of the presentation layer and/or content layer—via a content generator configured to automatically transform a set of inputs—representing a content type, visual assets, interactive format, context, theme, etc.—into the content layer. For example, the ad platform can implement adversarial and convolutional neural networks to train the content generator accordingly.

### 8. Predefined Interactive Advertisements

In one implementation, the ad platform can preassemble an interactive advertisement by combining a set of assets—extracted from a digital advertisement—with a particular presentation layer. The ad platform can then store this interactive advertisement for later deployment to ad slots viewed across a population of computing devices.

For example, the ad platform can generate a set of presentation layers including: a first presentation layer defining a first interactive format+and a first asset layout; a second presentation layer defining the first interactive format+and a second asset layout; a third presentation layer defining a second interactive format+and the first asset layout; a fourth presentation layer defining the second interactive format+and the second asset layout; etc.

In this example, the ad platform can then: extract a set of visual assets—such as including a call-to-action, a hyperlink to an external webpage, a logo, a description, a title, a video ad, a set of images, a color scheme—from a digital advertisement; transform the set of visual assets into a first interactive advertisement according to the first presentation layer; transform the set of visual assets into a second interactive advertisement according to the second presentation layer; transform the set of visual assets into a third interactive advertisement according to the third presentation layer; and transform the set of visual assets into a fourth interactive advertisement according to the fourth presentation layer.

The ad platform can then implement methods and techniques described above to derive an outcome model(s) configured to select a particular interactive advertisement in the set of interactive advertisements—including the first, second, third, and fourth interactive advertisements—for serving to ad slots based on ad slot characteristics and/or environmental characteristics associated with these ad slots.

### 9. Real-Time Interactive Ad Generation

In one implementation, the ad platform pairs a digital advertisement with a presentation layer in (near) real-time before serving this combination (i.e., the interactive ad) to a computing device that then renders the resulting interactive advertisement at the computing device. In this implementation, the ad platform can receive identification of a digital advertisement selected for an ad slot in an electronic document (e.g., webpage) accessed at a computing device (e.g., associated with a user) and match the digital advertisement with a presentation layer configured to visually modify the digital advertisement—according to a particular interactive ad format and/or asset layout within the particular ad format—and transform responsive to user inputs (e.g., user scrolling).

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
in response to receiving a first request for advertising content for presentation within a first ad slot loaded with a first webpage rendered by a first computing device accessed by a first user:
accessing a first set of ad slot characteristics comprising a first address corresponding to the first webpage;
in response to receiving identification of a first digital advertisement for presentation within the first ad slot:
extracting a set of visual assets, representing advertising content, from the first digital advertisement;
accessing a model linking ad slot characteristics to outcomes of interactive advertisements defining a set of presentation layers, each presentation layer, in the set of presentation layers, defining a particular interactive format and a particular layout of visual assets within the particular interactive format;
based on the first set of ad slot characteristics and the model, predicting a first outcome score for a first presentation layer, in the set of presentation layers, paired with the first digital advertisement, the first outcome score representative of a probability of the first user interacting with advertising content presented according to the first presentation layer and within the first ad slot, according to a first target outcome defined for the first digital advertisement; and
in response to the first outcome score exceeding a threshold outcome score:
selecting the first presentation layer for pairing with the first digital advertisement; and
transforming the set of visual assets according to the first presentation layer to generate a first interactive advertisement; and
in response to receiving a second request for advertising content for presentation within a second ad slot loaded with a second webpage rendered by a second computing device accessed by a second user:
accessing a second set of ad slot characteristics comprising a second address corresponding to the second webpage; and
in response to receiving identification of the first digital advertisement for presentation within the second ad slot:
based on the second set of ad slot characteristics and the model, predicting a second outcome score for the first presentation layer paired with the first digital advertisement, the second outcome score representative of a probability of the second user interacting with advertising content presented according to the first presentation layer and within the second ad slot, according to the first target outcome; and
in response to the second outcome score falling below the threshold outcome score:
selecting a second presentation layer, in replacement of the first presentation layer, for pairing with the first digital advertisement; and
transforming the set of visual assets according to the second presentation layer to generate a second interactive advertisement.

2. The method of claim 1:
further comprising, during an initial time period:
serving a set of interactive advertisements to ad slots rendered within webpages by a population of computing devices affiliated with a population of users;
accessing a corpus of ad slot characteristics representative of ad slots presenting the set of interactive advertisements during the initial tie period;
accessing a corpus of presentation layer characteristics representing a set of presentation layers selected for the set of interactive advertisements;
accessing a corpus of ad characteristics representing visual assets presented within the set of interactive advertisements;
accessing a corpus of engagement data representing interactions of users in the population of users with the set of interactive advertisements; and
deriving a model linking ad slot characteristics, ad characteristics, presentation layer characteristics, and outcomes of interactive advertisements based on the corpus of ad slot characteristics, the corpus of presentation layer characteristics, the corpus of ad characteristics, and the corpus of engagement data;
wherein receiving the first request comprises receiving the first request at a first time succeeding the initial time period; and
wherein receiving the second request comprises receiving the second request at a second time succeeding the initial time period.

3. The method of claim 1:
wherein extracting the set of visual assets from the first digital advertisement comprises extracting the set of visual assets from the first digital advertisement defining the first target outcome comprising video completion rate;
wherein predicting the first outcome score representative of the probability of the first user interacting with advertising content presented according to the first presentation layer and within the first ad slot according to the first target outcome comprises predicting the first outcome score representative of the probability of the first user interacting with advertising content presented according to the first presentation layer, and within the first ad slot, according to the first target outcome comprising video completion rate;
further comprising, in response to receiving a third request for advertising content for presentation within a third ad slot loaded with the second webpage rendered by a third computing device accessed by a third user:
accessing a third set of ad slot characteristics comprising the second address;
in response to receiving identification of a second digital advertisement, defining a second target outcome comprising click through rate, for presentation within the third ad slot:
extracting a second set of visual assets, representing advertising content, from the second digital advertisement;
based on the third set of ad slot characteristics and the model, predicting a third outcome score for the first presentation layer paired with the second digital advertisement, the third outcome score representative of a probability of the third user interacting with advertising content presented according to the first presentation layer and within the third ad slot, according to the second target outcome comprising click through rate; and
in response to the third outcome score exceeding the threshold outcome score:
selecting the first presentation layer for pairing with the second digital advertisement; and
transforming the second set of visual assets according to the first presentation layer to generate a third interactive advertisement.

4. The method of claim 1:
wherein selecting the first presentation layer comprises selecting the first presentation layer defining a first format and a first layout of visual assets within the first format; and
wherein selecting the second presentation layer comprises selecting the second presentation defining a second format and a second layout of visual assets within the second format.

5. The method of claim 1:
wherein selecting the first presentation layer comprises selecting the first presentation layer defining a first interactive format and a first layout of visual assets within the first interactive format; and
wherein selecting the second presentation layer comprises selecting the second presentation defining the first interactive format and a second layout of visual assets within the first interactive format.

6. The method of claim 5:
wherein extracting the set of visual assets from the first digital advertisement comprises extracting the set of visual assets from the first digital advertisement, the set of visual assets comprising a call-to-action and a digital video;
wherein selecting the first presentation layer defining the first format and the first layout of visual assets comprises selecting the first presentation layer defining:
the first interactive format defining animation of the set of visual assets within the first presentation layer; and
the first layout defining a first position of the call-to-action below the digital video within the first format; and
wherein selecting the second presentation layer defining the first format and the second layout of visual assets comprises selecting the second presentation layer defining:
the first interactive format; and
the second layout defining a second position of the call-to-action proximal a right side of the digital video within the first format.

7. The method of claim 1:
further comprising:
in response to receiving the first request for advertising content, accessing a first set of webpage characteristics corresponding to the first webpage based on the first address, the first set of webpage characteristics comprising a first visual scheme and a first content type defined for content presented within the first webpage; and
in response to receiving the second request for advertising content, accessing a second set of webpage characteristics corresponding to the second webpage based on the second address, the second set of webpage characteristics comprising a second visual scheme and a second content type defined for content presented within the second webpage;
wherein transforming the digital advertisement into the first interactive advertisement comprising visual assets, in the set of visual assets, presented according to the first presentation layer comprises:
generating a first creative layer for pairing with the first presentation layer, within the first ad slot, based on the first set of webpage characteristics; and
transforming the digital advertisement into the first interactive advertisement comprising visual assets, in the set of visual assets, presented according to the first presentation layer and the first creative layer; and
wherein transforming the digital advertisement into the second interactive advertisement comprising visual assets, in the set of visual assets, presented according to the second presentation layer comprises:
generating a second creative layer for pairing with the second presentation layer, within the second ad slot, based on the second set of webpage characteristics; and
transforming the digital advertisement into the second interactive advertisement comprising visual assets, in the set of visual assets, presented according to the second presentation layer and the second creative layer.

8. The method of claim 1, further comprising:
in response to serving the first interactive advertisement to the first ad slot for presentation to the first user, accessing a first set of engagement data representing interactions of the first user with the first interactive advertisement; and
rectifying the model based on the first set of engagement data, the first set of ad slot characteristics, and characteristics of the first presentation layer.

9. A method comprising:
during an initial time period:
serving a set of interactive advertisements to a set of ad slots rendered within webpages by a population of computing devices affiliated with a population of users, each interactive advertisement in the set of interactive advertisements comprising:
a set of assets representing advertising content for a first digital advertisement; and
a presentation layer, in a set of presentation layers, defining an interactive format and an asset layout for the set of assets;
accessing a corpus of ad slot characteristics of a corpus of ad slots presenting the set of interactive advertisements;
accessing a corpus of engagement data representing interactions of users, in the population of users, with the set of interactive advertisements; and
deriving a model associating ad slot characteristics and user engagement with the set of interactive advertisements based on the corpus of ad slot characteristics and the corpus of engagement data; and
during a first time period succeeding the initial time period, in response to receiving a first request for advertising content for presentation within a first ad slot loaded with a first webpage rendered by a first computing device accessed by a first user:
accessing a first set of ad slot data comprising a first address corresponding to the first webpage; and
in response to receiving identification of a first digital advertisement for presentation within the first ad slot:
based on the model and the first set of ad slot characteristics, predicting a first outcome score for a first interactive advertisement, the first outcome score representative of a probability of the first user interacting with the first interactive advertisement, presented within the first ad slot, according to a target outcome defined for the first digital advertisement, the first interactive advertisement comprising a first presentation layer, in the set of presentation layers, paired with the first digital advertisement; and
in response to the first outcome score exceeding a threshold outcome score, selecting the first interactive advertisement for presentation within the first ad slot.

10. The method of claim 9:
further comprising, during the initial time period, accessing a corpus of advertisement data representing characteristics of visual assets presented within the set of interactive advertisements;
wherein deriving the model associating ad slot characteristics and user engagement with the set of interactive advertisements based on the corpus of ad slot characteristics and the corpus of engagement data comprises deriving the model associating ad slot characteristics, characteristics of creative assets, and user engagement with the set of interactive advertisements based on the corpus of ad slot characteristics, the corpus of advertisement data, and the corpus of engagement data; and
wherein predicting the first outcome score for the first interactive advertisement based on the model and the first set of ad slot characteristics in response to receiving identification of the first digital advertisement comprises, in response to receiving identification of the first digital advertisement:
extracting a first set of visual assets, representing advertising content, from the first digital advertisement; and
predicting the first outcome score for the first interactive advertisement based on the first set of ad slot characteristics, the first set of visual assets, and the model.

11. The method of claim 10:
wherein accessing the corpus of ad slot characteristics comprises accessing the corpus of ad slot characteristics comprising a set of addresses of a set of webpages presenting the set of ad slots during the initial time period;
further comprising, during the initial time period, accessing a corpus of webpage characteristics corresponding to the set of addresses, the corpus of webpage characteristics comprising a set of content types of content presented within the set of webpages;
wherein deriving the model associating ad slot characteristics, characteristics of creative assets, and user engagement with the set of interactive advertisements based on the corpus of ad slot characteristics, the corpus of advertisement data, and the corpus of engagement data comprises deriving the model associating ad slot characteristics, characteristics of creative assets, webpage characteristics, and user engagement with the set of interactive advertisements based on the corpus of ad slot characteristics, the corpus of advertisement data, the corpus of webpage characteristics, and the corpus of engagement data;
further comprising, during the first time period, accessing a set of webpage characteristics corresponding to the first webpage based on the first address, the set of webpage characteristics comprising a first content type, in the set of content types, of content presented within the first webpage; and
wherein predicting the first outcome score for the first interactive advertisement based on the first set of ad slot characteristics, the first set of visual assets, and the model comprises predicting the first outcome score for the first interactive advertisement based on the first set of ad slot characteristics, the first set of visual assets, the first set of webpage characteristics, and the model.

12. The method of claim 9, further comprising, during a setup period preceding the initial time period:
accessing a digital advertisement comprising a set of assets representing advertising content;
accessing a set of presentation layers, each presentation layer, in the set of presentation layers, defining an interactive ad format, in a set of interactive ad formats, and a particular asset layout for arranging the set of assets within the interactive advertisement format; and
transforming the set of assets into the set of interactive advertisements according to the set of presentation layers.

13. The method of claim 9, wherein selecting the first interactive advertisement for presentation within the first ad slot comprises:
selecting the first presentation layer for pairing with the first digital advertisement in the first ad slot;
accessing a set of visual assets, defining advertising content, from the first digital advertisement;
transforming the set of visual assets into the first interactive advertisement according to the first presentation layer; and
at the first ad slot, rendering the first interactive advertisement responsive to an event that locates the first ad slot within a viewing window of the first computing device.

14. The method of claim 9:
in response to serving the first interactive advertisement to the first ad slot for presentation to the first user, accessing a first set of engagement data representing interactions of the first user with the first interactive advertisement; and
rectifying the model based on the first set of engagement data, the first set of ad slot characteristics, and characteristics of the first presentation layer.

15. A method comprising:
receiving a request for advertising content for presentation within a first ad slot loaded with a webpage rendered by a computing device accessed by a user; and
in response to receiving the request:
accessing a set of ad slot characteristics comprising an address corresponding to the webpage;
in response to receiving identification of a digital advertisement for presentation within the ad slot:
extracting a set of visual assets, representing advertising content, from the digital advertisement;
selecting a first presentation layer, in a set of presentation layers, for pairing with the digital advertisement, in the first ad slot, based on the set of visual assets and the set of ad slot characteristics, the first presentation layer defining a set of presentation layer characteristics comprising a first interactive format, in a set of interactive formats, and a first layout of visual assets within the first interactive format; and
transforming the set of visual assets into an interactive advertisement according to the first presentation layer;
rendering the interactive advertisement within the ad slot responsive to an event that moves the ad slot within a viewing window of the computing device; and
based on the event, generating an engagement metric for a user interacting with the interactive advertisement within the ad slot.

16. The method of claim 15:
further comprising, in response to receiving the request, accessing a set of webpage characteristics of the webpage based on the address, the set of webpage characteristics comprising a content type of content presented within the webpage;
wherein extracting the set of visual assets from the digital advertisement comprises extracting the set of visual assets from the digital advertisement defining a first target outcome in a set of target outcomes;
wherein selecting the first presentation layer for pairing with the digital advertisement, in the first ad slot, based on the set of visual assets and the set of ad slot characteristics comprises, based on the set of visual assets, the set of ad slot characteristics, and the set of webpage characteristics:
selecting the first presentation layer for pairing with the digital advertisement, in the first ad slot; and
selecting a first creative layer, in a set of creative layers, for pairing with the first presentation layer, the first creative layer defining a first subset of visual assets, in the set of visual assets, for pairing with the first presentation layer in the ad slot; and
wherein transforming the set of visual assets into the interactive advertisement according to the first presentation layer comprises transforming the subset of visual assets into the interactive advertisement according to the first presentation layer and the first creative layer.

17. The method of claim 15:
wherein receiving the request for advertising content comprises receiving the request for advertising content at a first time;
further comprising, during an initial time period preceding the first time:
serving a set of interactive advertisements to ad slots rendered within webpages by a population of computing devices affiliated with a population of users;
for each interactive advertisement in the set of interactive advertisements:
accessing a set of ad slot characteristics, in a corpus of ad slot characteristics, of an ad slot presenting the interactive advertisement;
accessing a set of presentation layer characteristics, in a corpus of presentation layer characteristics, of a presentation layer, in a set of presentation layers, selected for the interactive advertisement;
accessing a set of ad characteristics, in a corpus of ad characteristics, representing characteristics of a set of visual assets presented according to the presentation layer within the interactive advertisement; and
accessing a set of engagement data, in a corpus of engagement data, representing interactions of a user, in the population of users, with the interactive advertisement; and
deriving a model linking ad slot characteristics, ad characteristics, presentation layer characteristics, and outcomes of interactive advertisements based on the corpus of ad slot characteristics, the corpus of presentation layer characteristics, the corpus of ad characteristics, and the corpus of engagement data; and
wherein selecting the first presentation layer based on the set of visual assets and the set of ad slot characteristics comprises selecting the first presentation layer based on a target outcome defined for the digital advertisement, the set of visual assets, the set of ad slot characteristics, and the model.

18. The method of claim 15, further comprising, receiving a second request for advertising content for presentation within a second ad slot loaded with a second webpage rendered by a second computing device accessed by a second user; and
in response to receiving the second request:
accessing a second set of ad slot characteristics comprising a second address corresponding to the second webpage;
extracting the first set of visual assets from the digital advertisement selected for presentation within the second ad slot;
selecting a second presentation layer, in the set of presentation layers, for pairing with the digital advertisement, in the second ad slot, based on the first set of visual assets and the second set of ad slot characteristics, the second presentation layer defining a second set of presentation layer characteristics comprising the first interactive format and a second layout of visual assets within the first interactive format;
transforming the digital advertisement into a second interactive advertisement according to the second presentation layer; and
rendering the second interactive advertisement within the second ad slot responsive to a second event that moves the second ad slot within a viewing window of the second computing device.

19. The method of claim 18, further comprising, rectifying the model based on the set of ad slot characteristics, the set of presentation layer characteristics, a set of ad characteristics representing the first set of visual assets, and the engagement metric.

20. The method of claim 18, wherein selecting the first presentation layer based on the target outcome defined for the digital advertisement, the set of visual assets, the set of ad slot characteristics, and the model comprises:
based on the set of ad slot characteristics, the set of visual assets, and the model, predicting an outcome score for the first presentation layer paired with the digital advertisement, the outcome score representative of a probability of the user interacting with advertising content of the digital advertisement presented according to the first presentation layer, and within the ad slot, according to the target outcome defined for the digital advertisement; and
based on the outcome score, selecting the first presentation layer for pairing with the first digital advertisement.
